(19) United States
(12) Patent Application Publication
(10) Pub. No.: US 2015/0248854 A1
(43) Pub. Date: Sep. 3, 2015

(54) ADAPTABLE LOW-POWER DRIVER FOR LCD DISPLAYS

(71) Applicant: Cambridge Silicon Radio Limited, Cambridge (GB)

(72) Inventor: Jens Bertolt Zolnhofer, Cambridge (GB)

(73) Assignee: Cambridge Silicon Radio Limited, Cambridge (GB)

(21) Appl. No.: 14/193,464

(22) Filed: Feb. 28, 2014

(51) Int. Cl. G09G 3/18

(52) U.S. Cl. CPC G09G 3/18; G09G 2320/0233; G09G 2330/021; G09G 2320/041

(57) ABSTRACT

A display driver for providing drive voltages to an LCD display, comprising a first resistive ladder, a second resistive ladder, of higher resistance than the first resistive ladder; and a switching arrangement configured to connect the first resistive ladder to provide a drive voltage to the display for a first period, during which the voltage across the display is settling, and disconnect the first resistive ladder from providing that drive voltage during a second period, during which the voltage across the display is settled and the display driver is configured such that the second resistive ladder holds the drive voltage on the display

This invention relates to a circuit for generating a drive voltage for a display.

A liquid crystal display (LCD) uses liquid crystals to modulate light from an external light source. Each pixel is usually formed from a layer of liquid-crystal molecules aligned between two transparent electrodes and two polarising filters (one perpendicular to the other). In most LCDs the liquid crystal molecules have a twisted structure, which rotates the polarisation of light entering the liquid crystal layer from the external light source. The pixel correspondingly appears grey. Applying an electric field across the electrodes causes the liquid-crystal molecules to untwist. The polarisation of light entering the liquid crystal layer is no longer rotated and so light is blocked by the second polarisation filter. The pixel appears black. Controlling the voltage applied across the liquid crystal layer controls the degree to which the liquid crystal molecules untwist. Consequently light can be passed through the display in varying amounts by controlling the drive voltage.

Liquid crystal molecules lose their structure over time if subjected to a constant DC voltage. Consequently LCDs are driven by ac voltages. A typical frequency might be, for example, 200 Hz, as it is fast enough for the human eye not to notice the switching (which normally requires a frequency of more than 60 Hz), but low enough to facilitate easy design with low power consumption. It is important that the drive voltage is accurately generated, otherwise the constantly changing voltage will incorporate a DC component. It is also important that the display sees a symmetrical rise and fall in both directions. Random jitter is tolerable because it will cancel out over time, but any consistent mismatch between rise and fall times will lead to an unwanted DC component across the liquid crystal.

One suitable circuit for providing the drive voltages for an LCD is a resistive ladder. It generates voltages accurately and has a symmetrical rise and fall. A disadvantage is that a resistive ladder is always on and hence pulling current. This is not ideal for low power devices whose batteries need to last for several years. Therefore, there is a need for an improved display driver for low power implementations.

According to a first embodiment, there is provided a display driver for providing drive voltages to an LCD display, comprising a first resistive ladder, a second resistive ladder, of higher resistance than the first resistive ladder and a switching arrangement configured to connect the first resistive ladder to provide a drive voltage to the display for a first period, during which the voltage across the display is settling, and disconnect the first resistive ladder from providing that drive voltage during a second period, during which the voltage across the display is settled and the display driver is configured such that the second resistive ladder holds the drive voltage on the display.

The resistive ladder may comprise a plurality of resistive components connected in series.

The switching arrangement may be configured to provide a particular drive voltage to the display by connecting one or more of the plurality of resistive components to the display.

The switching arrangement may be configured to provide a particular drive voltage by selecting resistive components for connection to the display having a combined resistance that, as a proportion of the combined resistance of the plurality of resistive components, is equal to the proportion of the drive voltage relative to the voltage across the plurality of resistive components. The proportions may correspond to a required logic level.

Each of the first and second resistive ladders may be capable of providing the same one or more drive voltages to the display as the other.

Each of the first and second resistive ladders may be connected to have the same voltage across its plurality of resistive components as the other.

The first resistive ladder may be connected between the same supply voltages as the second resistive ladder.

The first and second resistive ladders may be connected between the same supply voltages and the switching arrangement may be connected between them.

The second resistive ladder may be connected to the display during the first and second periods.

The display driver may comprise or more comparators configured to determine if the voltage across the display has settled.

The display driver may be configured to determine that the voltage across the display is settled if a predetermined time has elapsed since the first resistive ladder was connected to provide that voltage.

The switching arrangement may be configured to, each time that connections to the LCD display's segments change, connect the first resistive ladder to provide the drive until the voltage across the display settles.

The switching arrangement may be configured to, each time that connections to the LCD display's segments change, enable one or more comparators to determine if the voltage across the display has settled.

The display driver may be capable of providing multiple different voltages to the display.

The display driver may comprise multiple outputs, each capable of providing a different drive voltage to the display.

The switching arrangement may be configured to connect the first resistive ladder to one or more of said outputs during the first period in order to facilitate fast settling across the display of the voltages provided by those one or more outputs.

The second resistive ladder may be connected to all of the multiple outputs during the first period.

Only outputs that are connected to the first resistive ladder in addition to the second resistive ladder may be capable of facilitating fast settling across the display

The second resistive ladder may be connected to all of the multiple outputs during the second period, whereby the second resistive ladder is capable of holding, during the second period, any of the drive voltages provided by the first resistive ladder during the first period.

According to a second embodiment, there is provided a method for providing drive voltages to an LCD display comprising connecting a first resistive ladder to provide a drive voltage for a first period, during which the voltage across the display is settling and disconnecting the first resistive ladder from providing that drive voltage for a second period, during which the voltage across the display is settled; and holding the drive voltage on the display during the second period using a second resistive ladder, which has a lower resistance than the first resistive ladder.

The present invention will now be described by way of example with reference to the accompanying drawings. In the drawings:

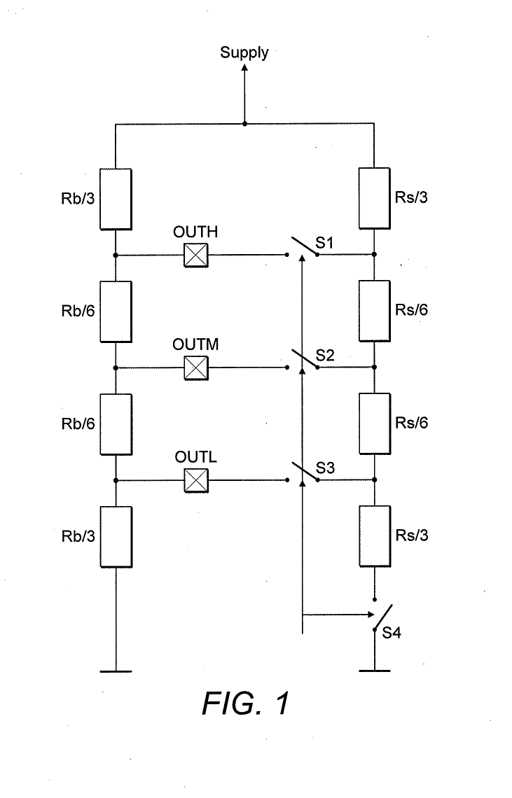

FIG. 1 shows an example of a display driver;

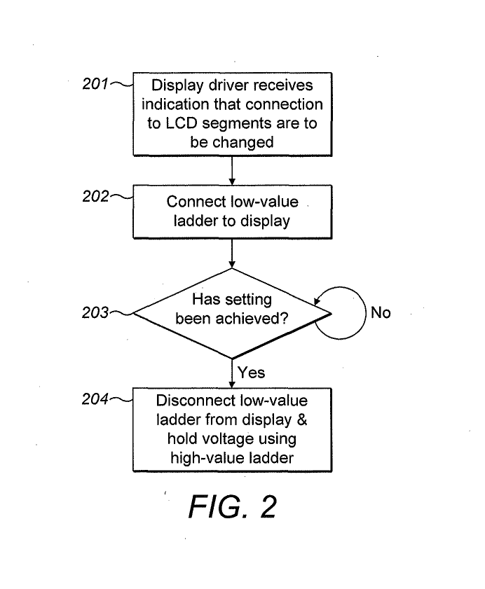

FIG. 2 shows an example of a method for driving a display; and

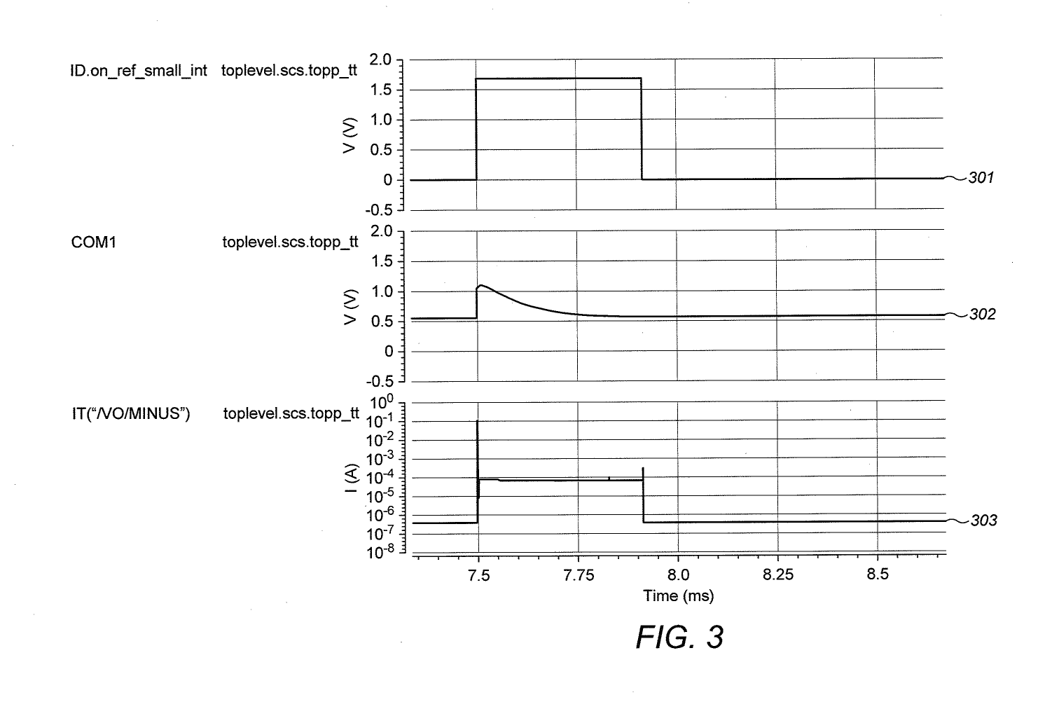

FIG. 3 shows an example of the voltage and current across a display.

A display driver for providing drive voltages to a display may comprise a first resistive ladder and a second resistive ladder, of higher resistance than the first one. The display driver may also comprise a switching arrangement configured to connect the first resistive ladder to provide a particular drive voltage to the display for a first period. This first period suitably corresponds to a time during which the voltage across the display is settling. The switching arrangement may be configured to disconnect the first resistive ladder from providing that drive voltage once the voltage across the display is settled. The drive voltage for the display is then held by the second resistive ladder. In this way a relatively high current can be provided to facilitate fast settling, which is changed to a relatively low current once settling has been achieved by switching from a relatively low-value resistive ladder to a relatively high-value resistive ladder. The post-settling low current serves to compensate any leakage current through the LCD display while the settled voltage is held in-between changes of voltage.

In one convenient embodiment the second resistive ladder is permanently connected to the display. An alternative would be for the second resistive ladder to be switchably connected to the display. The switching arrangement might be configured to connect the second resistive ladder to hold the drive voltage as it disconnects the first resistive ladder, so that the second resistive ladder is connected to provide the drive voltage during the second period but not the first.

The conditions that are met for the voltage across the display to be considered “settled” are likely to be user-defined and dependent on the requirements of individual implementations. Requiring a good level of settling will need higher current consumption and may add circuit complexity (e.g. in the comparators); therefore, for low-power implementations, a looser definition of “settling” is likely to be preferred than might be applied in other, more precise implementations. The voltage across the display may be considered to have settled when it is approaching its final value. As an example, the voltage may be considered to have settled when it is within a few tens of mV of its final value. The voltage across the display may be within 40 mV of its final value, preferably within 20 mV and most preferably within 10 mV.

An example of a display driver is shown in FIG. 1. The driver comprises two resistive ladders (also called resistive dividers): one, having a relatively high resistance on the left and another one, having a relatively low resistance on the right. The term “resistive ladder” is used herein to denote a circuit of more than one component that is capable of controlling the current flowing through it by providing resistance and several tap-points. In the example of FIG. 1, each of the resistive ladders comprises multiple resistive components connected together. A switching arrangement (positioned between the two ladders in the example of FIG. 1) enables chosen ones of the resistive components to be connected to the display. The resistive ladders act as dividers for connecting a proportion of the supply voltage to the display. Typically, the voltages that could be provided would be either Supply, Ground and ½*Supply or ⅓*Supply and ⅔*Supply, depending on the application and display used.

Rb denotes a relatively large resistance value. It might suitably be in the order of MΩ. Rs denotes a relatively small resistance value. It might suitably be in the order of kΩ. The current through the resistive divider on the left will be significantly smaller than the current through the divider on the right for a given supply voltage.

In the circuit shown in FIG. 1 the two resistive ladders are connected between the same supply voltages, so each ladder has the same voltage across it. The ladders also include equivalent resistive components; although their absolute resistive values are different, they display the same proportional relationship. Hence both ladders are capable of providing the same drive voltages to the display.

The switching arrangement is connected between the ladders. This arrangement provides for a particularly straightforward implementation. Current will always favour the low resistance path; thus when the appropriate combination of switches S1 to S4 is closed, the low-value ladder provides the drive voltages to facilitate fast settling. The high-value ladder remains connected to provide the hold voltages after opening these switches (essentially disconnecting the low-value ladder).

Alternative arrangements are also possible. For example, it can be envisaged that the ladders might be connected to different supply voltages or comprise different numbers of resistive components and still be capable of providing the same drive voltage to the display. Such arrangements are likely to be more complex than the circuit shown in FIG. 1, however, and may require additional components.

OUTH, OUTL, OUTM, Supply and Ground may be rails to which an LCD display can be connected via switches in the chip pad ring (not shown). Each of OUTH, OUTL and OUTM may be connected to the low-value resistor via switches S1 to S3. Switch S4 enables the settling circuit and allows a current to flow through the low-value ladder. The ladders shown are capable of generating voltages corresponding to logic levels {0, ½, 1} and {0, ⅓, ⅔, 1}.

The control logic of the LCD rail-generator preferably receives a signal from the main digital block on the integrated circuit when the connections across an LCD segment are about to be changed. The control signals from the logic block (represented by the arrows in FIG. 1) then close switches S4, S1 and S3 or S4 and S2, depending on which rails are required for the particular LCD to be driven. This results in fast settling of the following outputs to the voltages given in the table:

| | Output voltages | | |
|---|---|---|---|
| Switches closed | OUTH | OUTM | OUTL |
| S1, S3, S4 | 2 Vₛ/3 | N/A | Vₛ/3 |
| S2, S4 | N/A | Vₛ/2 | N/A |

Vₛ represents the supply voltage. All three output rails are available in both scenarios (via the resistive divider on the left); however faster settling via the resistive divider on the right is only available for the scenarios denoted in the table.

It can be seen from the table that, with the addition of Supply and Ground, the display driver is capable of generating logic levels {0, ½, 1} and {0, ⅓, ⅔, 1}. This is just one example. The number of logic levels capable of being generated by the circuit can be tailored for a particular implementation by adjusting the number and value of the resistive components in the ladders, as would be readily understood by one of skill in the art.

The relatively high current that flows through the low-value ladder allows the voltages on the rails supplying the LCD to settle quickly. Once those voltages have settled, switches S4, S1 and S3 or S4 and S2 will be opened again so that the voltages on the output rails are held by the high-value ladder on the left. In effect, this causes the display to switch from being connected to the low-value ladder and to the high-value ladder to being connected to the high-value ladder only. The relative low current that flows through the high-value ladder is sufficient to hold the voltage across the display in case of any leakage through the segments of the LCD.

The display driver is suitably capable of determining when the rails supplying the LCD have settled. One option is to use low-power comparators to sense when settling has been achieved. One comparator may be provided for each rail. The comparators are preferably only enabled temporarily, to save power. For example, the comparators may be enabled when the connections to the LCD segments are to be changed and may then be disabled as soon as they indicate that settling has been achieved. Another option is for the driver to allow a fixed time for settling. This option might be particularly suitable if the capacitance of the LCD is known and fixed so that settling time can be predicted in advance with a reasonable degree of accuracy.

An example of a method for driving a display is shown in FIG. 2. The method starts with the display driver receiving a signal indicating that the connections to the LCD segments are to be changed (step 201). In response, the display driver causes the low-value ladder to be connected to the display (step 202). The display driver may also enable circuitry which can sense when settling of the outputs has occurred (typically this circuitry would include one or more comparators). This circuitry within the display driver then determines when settling of the driver voltage has been achieved (step 203). Once settling is achieved, the display driver switches the low-value ladder off and only leaves the high-value ladder connected until the LCD display switches again (step 204).

The plots in FIG. 3 show, from top to bottom, the signal that enables the low-value resistive ladder (301), the differential voltage across one of the LCD segments (302) and the current (on log-scale) from the supply (303). The plots show that the display driver is capable of supplying a large current as long as this is required to facilitate quick settling of the voltage across the LCD segment. Once settling of the voltage across the LCD segment has been achieved, the display driver consumes no more current than is necessary to counter any leakage in the display.

The display driver described herein may save considerable power compared with a single ladder implementation. These savings are possible because the display's settling time represents only a small fraction of the typical time between LCD segment switching. Often the settling time will only be a few tens or hundreds of μseconds, compared with a total period of 5 msec between switched connections for a switching frequency of 200 Hz. The power saving depends on the size of the display—the smaller the display the shorter the settling time—as well as the switching frequency.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A display driver for providing drive voltages to an LCD display, comprising:
a first resistive ladder;
a second resistive ladder, of higher resistance than the first resistive ladder; and
a switching arrangement configured to connect the first resistive ladder to provide a drive voltage to the display for a first period, during which the voltage across the display is settling, and disconnect the first resistive ladder from providing that drive voltage during a second period, during which the voltage across the display is settled and the display driver is configured such that the second resistive ladder holds the drive voltage on the display.

2. A display driver as claimed in claim 1, the resistive ladder comprising a plurality of resistive components connected in series.

3. A display driver as claimed in claim 2, the switching arrangement being configured to provide a particular drive voltage to the display by connecting one or more of the plurality of resistive components to the display.

4. A display driver as claimed in claim 3, the switching arrangement being configured to provide a particular drive voltage by selecting resistive components for connection to the display having a combined resistance that, as a proportion of the combined resistance of the plurality of resistive components, is equal to the proportion of the drive voltage relative to the voltage across the plurality of resistive components.

5. A display driver as claimed in claim 4, in which the proportions correspond to a required logic level.

6. A display driver as claimed in claim 1, in which each of the first and second resistive ladders is capable of providing the same one or more drive voltages to the display as the other.

7. A display driver as claimed in claim 1, in which each of the first and second resistive ladders is connected to have the same voltage across its plurality of resistive components as the other.

8. A display driver as claimed in claim 1, the first resistive ladder being connected between the same supply voltages as the second resistive ladder.

9. A display driver as claimed in claim 1, the first and second resistive ladders being connected between the same supply voltages and the switching arrangement being connected between them.

10. A display driver as claimed in claim 1, configured such that the second resistive ladder is connected to the display during the first and second periods.

11. A display driver as claimed in claim 1, comprising one or more comparators configured to determine if the voltage across the display has settled.

12. A display driver as claimed in claim 1, the display driver being configured to determine that the voltage across the display is settled if a predetermined time has elapsed since the first resistive ladder was connected to provide that voltage.

13. A display driver as claimed in claim 1, the switching arrangement being configured to, each time that connections to the LCD display's segments change, connect the first resistive ladder to provide the drive until the voltage across the display settles.

14. A display driver as claimed in claim 1, the switching arrangement being configured to, each time that connections to the LCD display's segments change, enable one or more comparators to determine if the voltage across the display has settled.

15. A display driver as claimed in claim 1, capable of providing multiple different voltages to the display.

16. A display driver as claimed in claim 1, comprising multiple outputs, each capable of providing a different drive voltage to the display.

17. A display driver as claimed in claim 16, the switching arrangement being configured to connect the first resistive ladder to one or more of said outputs during the first period in order to facilitate fast settling across the display of the voltages provided by those one or more outputs.

18. A display driver as claimed in claim 16, configured such that the second resistive ladder is connected to all of the multiple outputs during the first period.

19. A display driver as claimed in claim 18, whereby only outputs that are connected to the first resistive ladder in addition to the second resistive ladder are capable of facilitating fast settling across the display

20. A display driver as claimed in claim 16, configured such that the second resistive ladder is connected to all of the multiple outputs during the second period, whereby the second resistive ladder is capable of holding, during the second period, any of the drive voltages provided by the first resistive ladder during the first period.

21. A method for providing drive voltages to an LCD display comprising:
connecting a first resistive ladder to provide a drive voltage for a first period, during which the voltage across the display is settling; and
disconnecting the first resistive ladder from providing that drive voltage for a second period, during which the voltage across the display is settled; and
holding the drive voltage on the display during the second period using a second resistive ladder, which has a lower resistance than the first resistive ladder.
